(19) United States
(12) Patent Application Publication
(10) Pub. No.: US 2012/0189329 A1
(43) Pub. Date: Jul. 26, 2012

(54) IMAGE FORMING APPARATUS

(75) Inventors: Kenji TAMAKI, Tokorozawa-shi (JP); Masashi SUGANO, Tokyo (JP); Akinori KIMATA, Toyokawa-shi (JP); Katsunori TAKAHASHI, Tokyo (JP); Akifumi ISOBE, Hidaka-shi (JP); Satoshi SHIMAO, Tokyo (JP)

(73) Assignee: KONICA MINOLTA BUSINESS TECHNOLOGIES, INC., Tokyo (JP)

(21) Appl. No.: 13/347,183

(22) Filed: Jan. 10, 2012

(30) Foreign Application Priority Data
Jan. 21, 2011 (JP) 2011-011070

(51) Int. Cl. G03G 15/00; G03G 15/20

(52) U.S. Cl. 399/38; 399/67; 399/122; 399/44; 399/401; 399/82

(57) ABSTRACT

Provided is an image forming apparatus having a first sheet dimension sensor at a conveyance path in a reverse conveyance section 50, wherein the first sheet detection sensor 75 detects a front edge and a rear edge of the sheet P in a sheet conveyance direction so as to detect a first sheet dimension. According to the above configuration, since only a sensor has to be disposed at the conveyance path in the reverse conveyance section 50 so as to detect the sheet dimension in the sheet conveyance direction, a first sheet dimension can be detected by an economical sensor configuration.

This application is based on Japanese Patent Application No. 2011-011070 filed on Jan. 21, 2011 in Japanese Patent Office, the entire content of which is hereby incorporated by reference.

### TECHNICAL FIELD

The present invention relates to an image forming apparatus.

### BACKGROUND OF THE INVENTION

An image forming apparatus such as a printer and a copying machine employing an electrophotographic method has been know. In the image forming apparatus, to form a toner image on a sheet, processes in which the toner image is transferred onto the sheet and then the toner image is fixed on the sheet are carried. In the above type of image forming apparatus in case two-side printing is performed, there is suggested a method to turn over the sheet so that writing start positions for the toner images to be written on a obverse and reverse surfaces of the sheet are based on the same edge section of the sheet so as to enhance positioning accuracy of obverse and reverse images (for example, Patent Document 1: Unexamined Japanese Patent Application Publication No.2007-31041).

In case of two-side image forming, as a former process, the fixing process associated with the image forming on the obverse surface is carried out. Since the sheet contracts by effects of heat due to the fixing process, magnification ratios the images formed on obverse and reverse surfaces may differ, if the image forming on the reverse surface is carried out in the same manner as that on the obverse surface.

For example in Patent Document 2: Unexamined Japanese Patent Application Publication No.2004-271739, a method to compensate the magnification ratios on the reverse and the obverse surfaces is disclosed. According to the method disclosed in the Patent Document 2, the sheet in course of conveyance is scanned by a CCD line sensor or a CIS line sensor configured with a plurality of light receiving elements disposed in a straight line along a sheet width direction (a direction perpendicular to a sheet conveyance direction on the sheet surface). Whereby, a first and second sheet dimensions are detected, as sheet dimensions (lateral and longitudinal dimension) in two directions which are perpendicular to each other on the sheet surface. Here, in case the sheet conveyance direction at a transfer position, where the image is transferred onto the sheet, is a datum, a width dimension in the sheet width direction perpendicular to the sheet conveyance direction on the sheet surface is a first sheet dimension and a sheet dimension in the sheet conveyance direction is a second sheet dimension.

Patent Document 1: Unexamined Japanese Patent Application Publication No.2007-31041

Patent Document 2: Unexamined Japanese Patent Application Publication No.2004-271739

However, according to the method disclosed in the Patent Document 2, in order to detect the first sheet dimension of various types of sheets, a line sensor has to be provided considering a maximum size of sheet which is applicable to the apparatus, which will cause a problem to increase the burden of the economy.

On the other hand, it is considered that the second sheet dimensions before and after the fixing are detected by disposing a photoelectric sensor at a downstream side with respect to the fixing position where the image is fixed onto the sheet in the conveyance path, then the contraction ratio of the sheet is calculated from the detected results so as to predict the first sheet dimension after fixing based on the contraction ratio.

However, the above methods are always based on presumption, and since the contraction ratios in the lateral and longitudinal directions of the sheet may differ each other, there is a problem that the first sheet dimension after fixing cannot be accurately known. Thus, as Patent Document 1 discloses, even if the writing start positions of the images of the obverse and reverse are set based on the same edge section of the sheet as the datum, there is a problem that a difference in the sized and a displacement between the images on the obverse and reverse surfaces occur.

### SUMMARY

The present invention has one aspect to solve the above problems and an object of the present invention is to accurately detect the first dimension representing the sheet dimension in the sheet width direction perpendicular to the sheet conveyance direction at the transfer position where the image is transferred onto the sheet while suppressing the burden of the economy.

1. To solve the above problem provided is an image forming apparatus to form images on obverse and reverse surfaces of a sheet by fixing the images transferred onto the sheet, comprising:

a main conveyance section to convey the sheet to a fixing position where the image transferred from a transfer position is fixed on the sheet, wherein in the transfer position the image is transferred onto the sheet;

a reverse conveyance section to receive the sheet passed through the fixing position from the main conveyance section and to turn over the sheet by rotating the sheet around a rotation axis parallel to a sheet conveyance direction at the transfer position, and

a first dimension detection section to detect a first sheet dimension by detecting front and rear edges of the sheet in a sheet conveyance direction while the sheet is being turned over.

2. It preferable that the image forming apparatus of item 1, further comprises:

a second dimension detection section to detect a second sheet dimension by detecting the front and the rear edges of the sheet in course of conveyance in the sheet conveyance direction.

3. It is further preferable that the image forming apparatus of item 1, further comprises:

a control section to conduct a magnification correction process including a detection process to detect the first sheet dimension and the second sheet dimension through the first dimension detection section and the second dimension detection section, and a computation process to compute a magnification correction value which corrects a magnification of the image based on the first sheet dimension and the second sheet dimension.

4. It is still further preferable that in the image forming apparatus of item 1, the control section conducts a process to convey the sheet through a two-side printing path which is a recurrence path from the main conveyance section to the main conveyance section via the reverse conveyance section and a process to detect the first and the second sheet dimensions respectively in course of the sheet conveyance.

### BRIEF DESCRIPTION OF THE DRAWINGS

FIG. 1 is a configuration diagram schematically showing an image forming apparatus related to a first embodiment.

FIG. 2 is a side view showing a relevant portion of a reverse conveyance section 50 when an image forming apparatus is viewed from a A1 direction shown by FIG. 1.

FIGS. 3a and 3b are a perspective view schematically showing a reverse conveyance path section for a sheet P and the reverse path 50.

FIG. 4 is a block diagram showing a control system of an image forming apparatus related to a first embodiment.

FIGS. 5a and 5b are an explanatory diagram schematically showing a first sheet dimension sensor 75.

FIG. 6 is a flow chart showing a processing procedure of obverse and reverse magnification ratio compensation representing a first operation pattern.

FIG. 7 is a flow chart specifically showing correction value computation.

FIG. 8 is a flow chart showing a processing procedure of obverse and reverse magnification ratio compensation representing a second operation pattern.

FIG. 9 is a flow chart specifically showing dimension detection processing.

FIG. 10 is a flow chart showing a procedure of a correction process of a magnification correction value pertaining to a second operation pattern.

FIG. 11 is a flow chart showing a processing procedure of a correction process of obverse and reverse magnification correction representing a third operation pattern.

FIG. 12 is a block diagram showing a control system of an image forming apparatus related to a second embodiment.

FIG. 13 is a flow chart showing a processing procedure of a correction process of a obverse and reverse magnification correction value representing a fourth operation pattern.

FIG. 14 is a flow chart showing a processing procedure of a correction process of a obverse and reverse magnification correction value representing a fifth operation pattern.

### DETAILED DESCRIPTION OF PREFERRED EMBODIMENTS

### First Embodiment

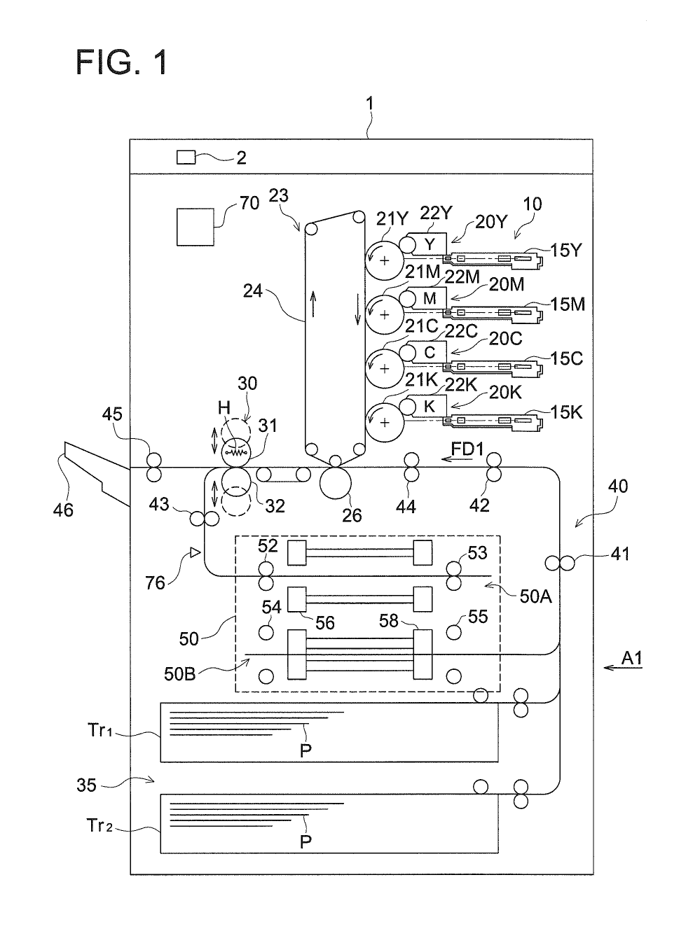

FIG. 1 is a configuration diagram schematically showing an image forming apparatus related to a first embodiment, The image forming apparatus is an image forming apparatus of the electrophotographic method, for example, such as a copying machine, wherein a full color image is formed by disposing a plurality of photoconductive members to face the one intermediate transfer belt, so called a tandem type color image forming apparatus.

The image forming apparatus is configured mainly with a document reading device 1, an image forming unit 10, a fixing device 30, a main conveyance section 40, a reverse conveyance section 50 and a control section 70.

The document reading device 1 is provided with an automatic document feeding device (unillustrated) disposed at an upper portion of the apparatus body so as to obtain an image signal by reading an image on the document while conveying the document by the automatic document feeding device. Specifically, the document reading device 1 radiates the image on the document by a lamp so that reflected light forms an image on a light receiving surface of a photographing element. The photographing element converts the incident light into an electric signal and outputs a given image signal to image reading control section 2.

The image reading control section 2 applies A/D conversion, shading correction and compression processing to the image signal and outputs as image data to the control section 70. Incidentally, the image data inputted to the control section 70 is not limited to the data read out by the document reading device 1, for example, it can be data received from a personal computer connected with the image forming apparatus or from other image &lining apparatus.

The image forming unit 10 transfers a toner image onto the sheet P based on the image data The image forming unit 10 is configured mainly with exposure sections 15Y, 15M, 15C and 15K, developing units 20Y, 20M, 20C and 20K, an intermediate transfer section 23 and a transfer roller 26.

Each of the exposure sections 15Y to 15K is configured with a laser light source, a polygon mirror, and a plurality of lens. Each exposure section 15Y to 15K carries out scan exposure by a laser beam on surfaces of the photoconductive drums 21Y. 21M, 21C and 21K to be described, in accordance with an output information outputted from the control section 70 based on the image data.

The charging developing unit 20Y is configured mainly with the photoconductive drum 21Y to rotate around a rotation axis and a charging developing section 22Y disposed at a vicinity thereof so as to form a toner image corresponding to yellow color on the photoconductive drum 1Y. The charging developing units 20M, 20C and 20K are configure in the same manner as charging developing unit 20Y where charging developing sections 22M, 22C and 22K are disposed in peripheral areas of the photoconductive drums 21M, 21C and 21K so as to form toner images corresponding to magenta, cyan and black colors respectively on the photoconductive drums 21M, 21C and 21K.

The photoconductive drums 21Y to 21K are charged evenly at the surfaces thereof by the charging developing sections 22Y to 22K. By scanning the surfaces with the laser beam along a direction parallel to the axis direction of the photoconductive drums 21Y to 21K, latent images are formed on the surfaces. Further, the charging developing sections 22Y to 22K visualize the latent images on the photoconductive drums 21Y to 21K by developing with toner. Whereby, toner images are formed on the surfaces of the respective photoconductive drums 21Y to 21K. The toner images formed on the respective photoconductive drums 21Y to 21K are sequentially transferred at given positions on the intermediate transfer belt 24 configuring the intermediate transfer section 23.

The transfer roller 26 transfers the toner image having been transferred onto the intermediate transfer belt 24 onto the sheet P being conveyed by the main conveyance section 40 at a given timing.

As above, the image forming unit 10, executes a successive process i.e. (1) charging the photoconductive drums 21Y to 21K, (2) forming latent images on the photoconductive drums 21Y to 21K by the exposure sections 15Y to 15K, (3) adhering the toner on the electrostatic latent image having been formed, (4) primarily transferring the toner image on the photoconductive drums 21 to 21K onto the intermediate transfer belt 24, (5) secondarily transferring the toner image on the intermediate transfer belt 24 onto the sheet P.

The sheet P on which the toner image is transferred, namely the sheet P having the toner image not fixed, is conveyed to the fixing device 30. The fixing device 30 fixes the toner image on to the sheet P by pressing and heating the sheet P. The fixing device 30 is configured mainly with an upper fixing roller 31 and a lower fixing roller 32. The upper fixing roller 31 and the lower fixing roller 32 are disposed to press each other. Under a pressurized state, a fixing nip section is formed between the upper fixing roller 31 and the lower fixing roller 32.

The upper fixing roller 31 and the lower fixing roller 32 are driven by an unillustrated mechanism to be able to move in a direction where a relative distance between them lengthens. Whereby, the upper fixing roller 31 and the lower fixing roller 32 can be switched from the pressurized state (nipping state) to a separated state (nipping released state). Also, by reversal operation of the aforesaid drive mechanism, the upper fixing roller 31 and the lower fixing roller 32 can be switched from the separated state to the pressurized state.

Inside the upper fixing roller 31 a heater H representing a heating section to fix the toner image on the sheet P by heat is installed. The upper fixing roller 31 is heated by radiation heat from the heater H. The heater H is controlled by the control section 70 by turning on/off of a power source based on a detection result of a sensor (unillustrated) to detect surface temperature of the upper fixing roller 31 so that the upper fixing roller 31 becomes a given temperature.

In the above fixing device 30, the sheet P is conveyed in a way that the surface subject to fixing (the surface having the toner image not fixed) faces the upper fixing roller 31 and passes through the fixing nip section in course of conveyance. Whereby, fixing of the toner image onto the sheet P is conducted through an action of the pressure applied by the upper fixing roller 31 and the lower fixing roller and the heat of the upper fixing roller 31.

The main conveyance section 40 conveys the sheet P fed from the sheet feeding section 35 (any one of a plurality of the sheet storing trays Tr1 and Tr2) in accordance with an instruction of a user. The main conveyance section 40 is provided with a conveyance path (conveyance direction FD1 of the sheet P) to convey the sheet P in a given direction and configured with a guide member (unillustrated), a plurality of rollers, for example, conveyance rollers 41 to 43 and registration rollers 44 and sheet ejection rollers 45.

The main conveyance section 40 supplies the sheet P to the transfer position at which the toner image is transferred to the sheet P in course of conveyance of the sheet P. Specifically, the main conveyance section 40 conveys the sheet P fed from the sheet feeding section 35 to the transfer roller 26 via the conveyance rollers 41, 42 and the registration rollers 44.

Also, the main conveyance section 40 supplies the sheet P to the fixing position (at which the toner image is fixed to the sheet P) from the transfer position in course of conveyance of the sheet P. Specifically, the main conveyance section 40 conveys the sheet P having been passed through the transfer position, namely the sheet P on which the toner image has been transferred, is conveyed to the fixing nip section.

Then, the sheet P passed through the fixing position is ejected on an ejected sheet tray 46 disposed on an outer side surface of the apparatus body via ejection rollers 45.

Contrarily, in case the toner image is to be formed on the reverse surface of the sheet P as well, the main conveyance section 40 conveys the sheet P having been subject to the fixing process on the obverse surface thereof, to a conveyance rollers 43 located at lower part via a guide section (unillustrated) then further conveys the sheet P to the reverse conveyance section 50 via the conveyance rollers 43. As described hereinafter, when the turning over of the sheet P is performed by the reverse conveyance section 50, the reverse conveyance section 50 sends out the sheet P to the main conveyance section 40. As above, the sheet P passed through the two-side printing path is conveyed to the transfer position and the fixing position by the main conveyance section 40 so as to perform image forming on the reverse surface.

When the sheet P conveyed from the main conveyance section 40 is received at a downstream side with respect to the fixing position by the reverse conveyance section 50, the reverse conveyance section 50 turns over the sheet P without counterchanging of the front edge and the rear edge of the sheet P which is to reach the transfer position between the image forming on the obverse surface and the image forming on the reverse surface. Then the reverse conveyance section 50 supplies sheet P after turning over to the main conveyance section 40 at an upstream side with respect to the transfer position. As above since the sheet P is turned over without counterchanging of the front edge and the rear edge of the sheet P in the reverse conveyance section 50, the obverse and the reverse images can be formed with reference to the same edge section of the sheet P, whereby positional accuracy between the obverse and reverse images can be enhanced.

Incidentally, in the present Specification, the front edge of the sheet P denotes an edge of the sheet P on the front side in the sheet conveyance direction and the rear edge denotes an edge of the sheet P on the rear side in the sheet conveyance direction. Namely, the front edge and the rear edge of the sheet P conveyed in a sheet conveyance direction FD1 represent the front edge and the rear edge of the sheet P in the sheet conveyance direction FD1, and the front edge and the rear edge of the sheet P conveyed in a sheet conveyance direction FD2 to be described represent the front edge and the rear edge of the sheet P in the sheet conveyance direction FD2.

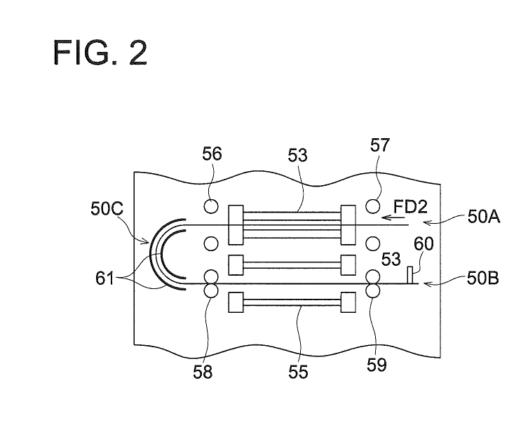

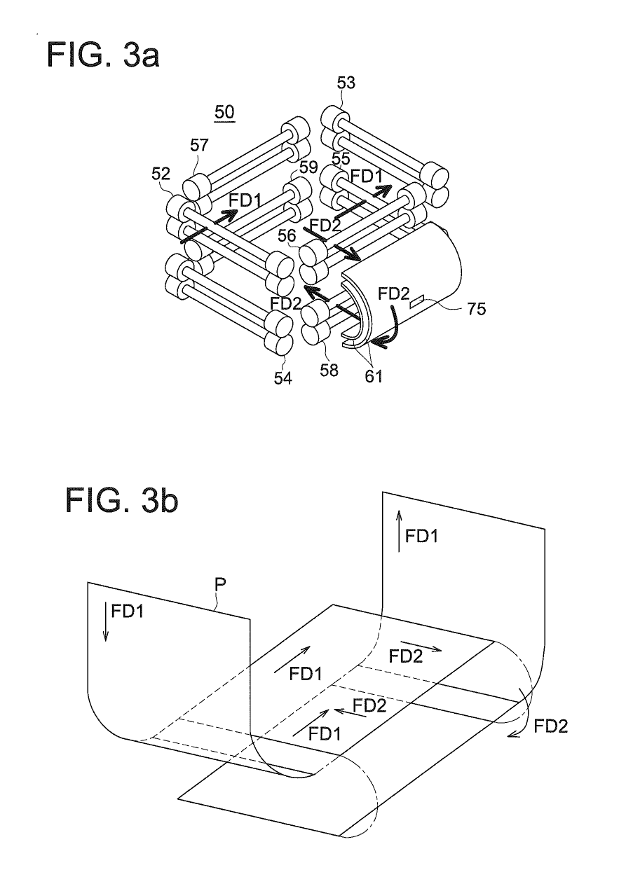

FIG. 2 is a side view showing a relevant portion of the reverse conveyance section 50 when the image forming apparatus is viewed from a A1 direction shown by FIG. 1. FIG. 3 is a perspective view schematically showing a configuration of the reverse conveyance section 50 and the reverse path of the sheet P. Specifically, the reversal conveyance section 50 is provided with a conveyance path (conveyance direction FD2 of the sheet P) to convey the sheet P in a direction perpendicular to a sheet conveyance direction FD1 (the sheet conveyance direction FD1 at the transfer position) in the main conveyance section 40. Also, the reverse conveyance section 50 turns the sheet P over by rotating the sheet P around the rotation axis which is parallel to the sheet conveyance direction at the transfer position. The reverse conveyance, section 50 is provided with a first reversal section 50A and the second reversal section 50B and the rotation conveyance path 50C.

The first reversal section 50A is provided with conveyance roller pairs 52 and 53 and reverse roller pairs 56 and 57. The conveyance roller 52 pair is configured with a rotation roller and a driven roller in contact with the rotation roller. The conveyance roller 52 pair is driven by unillustrated drive mechanism to be switched between a pressurized state (nipped state) and a separated state (nip released state). Each rotation roller is configured with a rotation axis and a pair of rollers disposed at both ends of the rotation axis and each driven roller is configured with a rotation axis and a pair of rollers disposed at both ends of the rotation axis. Incidentally, the configuration of the conveyance roller pair 52 is the same as that of conveyance roller pairs 53 to 55 and turn over roller pairs 56 to 59 which are to be described.

Each of conveyance roller pairs 52 and 53 is disposed so that the rotation axis of the roller is parallel to the sheet conveyance direction FD2, and the both conveyance roller pairs 52 and 53 are disposed to be opposite each other with a given distance. Also, the reverse roller pairs 56 and 57 are disposed so that the rotation axis of the roller is parallel to the sheet conveyance direction FD1, and the both conveyance roller pairs 52 and 53 are disposed to be opposite each other with a given distance.

The conveyance roller pairs 52 and 53 receive the sheet P passed through the fixing position from the main conveyance section 40 and conveys the sheet P to a first switching position to switch the conveyance direction from the sheet conveyance direction FD1 of the main conveyance section 40 to the sheet conveyance direction FD2 of the reverse conveyance section 50. The first switching position is a position where it is possible that the sheet P conveyed by the conveyance roller pairs 52 and 53 is nipped by the reverse roller pairs 56 and 57 and conveyed to a rotation conveyance path 50C.

The reverse roller pairs 56 and 57 convey the sheet P conveyed to the first switching position by the conveyance rollers pairs 52 and 53 along the sheet conveyance direction FD2. Specifically, the reverse roller pairs 56 and 57 convey the sheet P in a way that the reverse roller 57 set is on an upstream side and the reverse roller set 56 is on a downstream side so as to supply the sheet P to a second reverse section 50B via the rotation conveyance path 50C.

The second reversal section 50B is provided with reverse roller pairs 58 and 59, the conveyance roller pairs 54 and 55 and a side surface datum plate 60. Incidentally, a configuration of the reversal roller pairs 58 and 59 is the same as that of the reversal roller pairs 56 and 57 of the reversal section 50A, and a configuration of the conveyance roller pairs 54 and 55 is the same as that of the conveyance roller pairs 52 and 53 of the first reverse section 50A. Therefore, descriptions of duplicative portions will be omitted.

When the reverse roller pairs 58 and 59 receive the sheet P conveyed along the rotation conveyance path 50C, the reverse roller pairs 58 and 59 convey the sheet P to a second switching position at which the sheet conveyance direction FD2 of the reverse conveyance section 50 is switched to the sheet conveyance direction FD1 of the main conveyance section 40. The second switching position is a position where it is possible that the sheet P conveyed by the reverse roller pairs 58 and 59 is nipped by the conveyance roller pairs 54 and 55 and conveyed to a conveyance path in the main conveyance section 40 at an upstream side with respect to the transfer position.

The conveyance roller pairs 54 and 55 convey the sheet P conveyed by the reverse roller pairs 58 and 59 to the second switching position so that the conveyance direction of the sheet P corresponds to the sheet conveyance direction FD1. Specifically, the conveyance roller pairs 54 and 55 convey the sheet P in a way that the conveyance roller pair 54 is at upstream side and the conveyance roller pair 55 is at downstream side so as to supply the sheet P to the main conveyance section 40.

A side surface datum plate 60 is to correct bias and skew of the sheet P conveyed to the second reverse section 50B and is located at a position rather far from the reverse roller 59 outward. Also, the side surface datum plate 60 is in an elongate cuboid shape, and is disposed so that the longitudinal direction thereof is parallel to the conveyance direction. Since a side surface section of the sheet P contacts with an inside section of the side surface datum plate 60, the bias and the skew of the sheet P can be corrected.

The rotation conveyance path 50C is located between an exit side of the reverse roller set 56 of the first reverse section 50A and an entering side of the reverse roller set 58 of the second reverse section 50B. The rotation conveyance path 50C is configured with, for example, a pair of guide plates 61 made of metal members which are curved in an arc-like shape outward. Whereby, when the sheet P passes between the pair of the guide plates 61, the sheet P is turned over 180 degree around the rotation axis which is parallel to the sheet conveyance direction FD1 at the transfer position.

As above, different from the method such as switch back, the reverse conveyance section turns over the sheet P without changing front and rear edges of the sheet P and returns the sheet P to the main conveyance section 40.

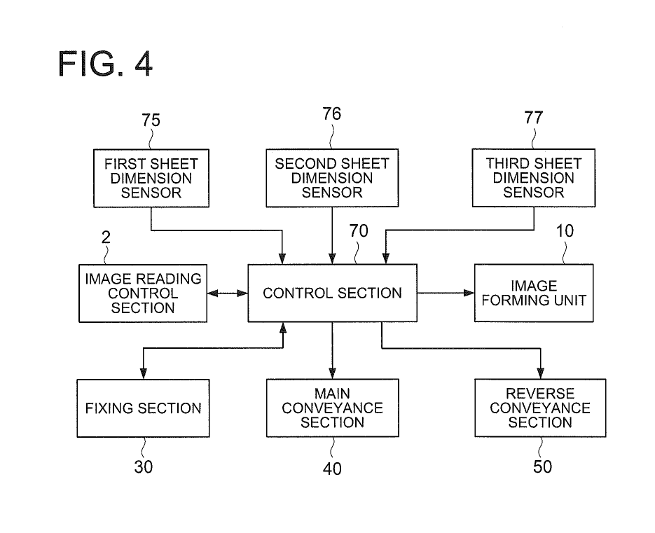

FIG. 4 is a block diagram showing a control system of the image forming apparatus related to the present embodiment. The control section 70 serves a function to control the image forming apparatus comprehensively. As the control section 70, for example, a micro computer configured mainly with a CPU, a ROM, a RAM, and an I/O interface is used. The control section 70 performs various kinds of computations in accordance with control programs stored in the ROM and controls operation of the image forming apparatus based on the computations.

The control section 70 executes a series of processes shown below by controlling each of sections i.e. the image forming unit 10, the fixing device 30, the main conveyance section 40 and the reverse conveyance section 50. Thereby, the toner image is formed on the sheet P. (1) charging the photoconductive drums 21Y to 21K, (2) forming the electrostatic latent image on the photoconductive drums 21Y to 21K by the exposure sections 15Y to 15K, (3) fixing toner onto the formed electrostatic latent image, (4) Primarily transferring the toner images on the photoconductive drums 21Y to 21K, onto the intermediate transfer belt 24, (5) Conveying the sheet P, (6) Secondarily transferring the toner image on the intermediate transfer belt 24 onto the sheet P, (7) Fixing the transferred toner image onto the sheet P, (8) At two-side printing, turning over the sheet P having passed through the fixing position then conveying the sheet P to the transfer position again.

In the relation to the present invention, the control section 70 performs an obverse and reverse magnification ratio correction process. If the sheet dimensions at time of toner image transferring onto the obverse surface of the sheet and at toner image forming onto the reverse surface of the sheet differ, size of the toner images and positional relation between the toner images may deviate between the obverse and the reverse surfaces. The magnification correction process matches the size and positional relation of the toner images formed on the obverse and reverse surfaces by controlling a laser beam in accordance with the change of the dimension of the sheet, by contracting the toner image formed on the reverse surface and by adjusting an image writing start position. koko

Since the change of the sheet dimension is mainly caused by the fixing process associated with image forming on the obverse sheet surface, the control section 70 calculates a changing ratio of the sheet dimension between after and before the fixing process on the sheet P. Then the control section 70 calculates the magnification correction value which compensates the magnification ratio of the toner image formed on the reverse surface of the sheet P. Incidentally, methods to match the size and positional relation of the toner image based on the magnification correction values are disclosed, for example, in Unexamined Japanese Patent Document No. 2005-301240 and so forth. Please refer to the above document if necessary. Incidentally, in the magnification correction process, the size and the positional relation of the toner images of the reverse and the obverse surfaces can coincide by calculating the magnification correction value which compensates the magnification ratio of the toner image formed on the obverse surface of the sheet P.

To execute the above obverse and the reverse magnification correction process, detection signals from various sensors are inputted to the control section 70.

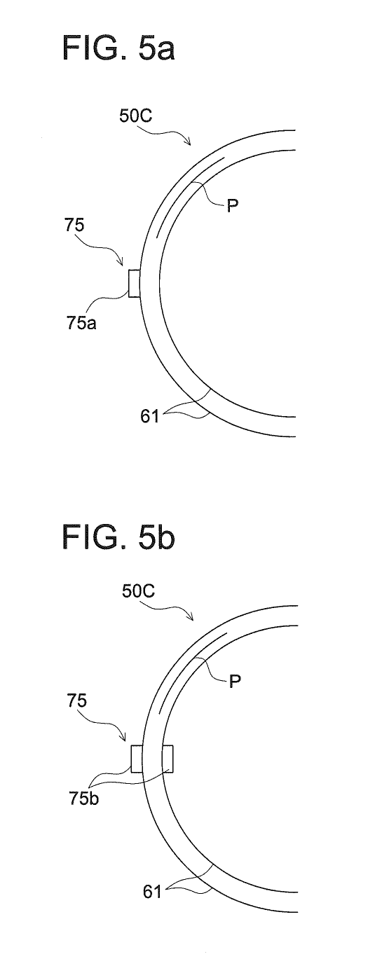

A first sheet dimension sensor 75 is disposed at the rotation conveyance path 50C in the reverse conveyance section 50 which detects a first sheet dimension with respect to the sheet P (sheet P conveyed in the sheet conveyance direction FD2) to be conveyed in the rotation conveyance path 50C (first dimension detection section). For example, as the sheet dimension sensor 75, as FIG. 5(a) shows, a reflection type photo sensor configured with, for example, a light emitting element and a light receiving element can be used. The reflection type photo sensor 75a outputs change of voltage of the light receiving element representing passage of the sheet P by the light from the light emitting element being reflected by the sheet P when the sheet P is conveyed. The first sheet dimension sensor 75 detects the first sheet dimension over based on the change of the voltage by detecting front and rear edges of the sheet P in the sheet conveyance direction FD2 while the sheet P being turned.

Incidentally, as the first sheet dimension sensor 75, besides the reflection type photo sensor 75a, a transmission type photo sensor 75b can be used. As FIG. 5b shows, the transmission type photo sensor 75b outputs the change of voltage of the light receiving element representing passage of the sheet P by interrupting the light from the light emitting element by the sheet P being conveyed.

Also, for example as FIG. 1 shows, the second sheet dimension sensor 76 is located at the conveyance path at downstream side with respect to the fixing position in the conveyance path in the main conveyance section 40. The second sheet dimension sensor 76 detects the second sheet dimension (second dimension detection) with respect to the sheet P conveyed in the above conveyance path (sheet P conveyed in the sheet conveyance direction FD1). In the same manner as the first sheet detection sensor 75, as the second sheet dimension sensor 76, the reflection type photo sensor or transmission type photo sensor can be used. The second sheet detection sensor 76 detects the front and rear edges of the sheet P in the sheet conveyance direction FD1 being conveyed in the main conveyance section 40 based on the change of voltage representing the output of the photo sensor so as to detect the second sheet dimension.

Incidentally, to the control section 70 besides the information from above sensors, a detection signal from a sheet amount sensor 77 which detects the sheet amount of the sheet P stored in each of sheet storing trays Tr1 and Tr2 and image data outputted from the aforesaid image reading control section 2 are inputted.

Operation as to the obverse and reverse magnification correction process of the image forming apparatus related to the present embodiment will be described as follow.

### (First Operation Pattern: Reverse and Obverse Magnification Correction at Power-On)

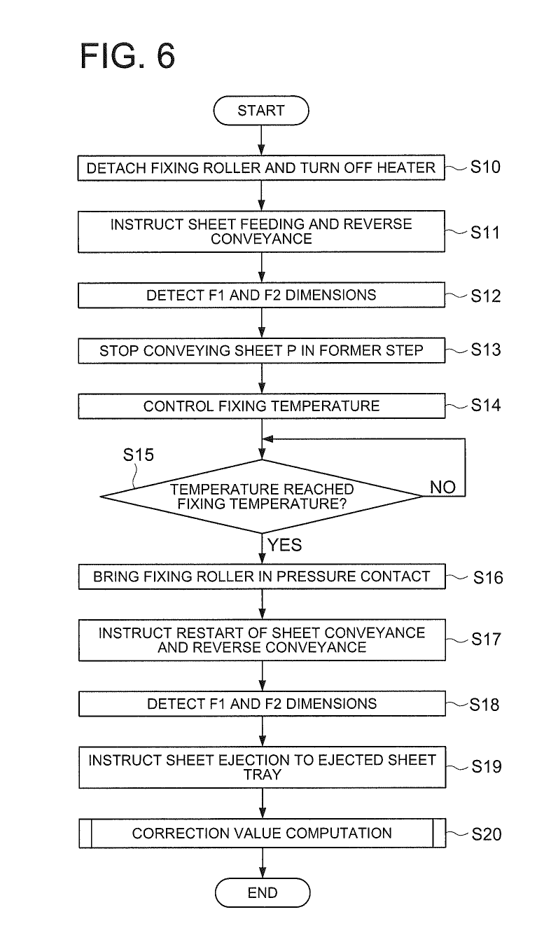

FIG. 6 is a flow chart showing a procedure of the obverse and reverse magnification correction process as a first operation pattern. The process shown by the flow chart (first operation pattern) is performed by the control section 70 along with power activation of the image forming apparatus.

First, in Step 10 (S10), the control section 70 sets the upper fixing roller 31 and the lower fixing roller 32 in a separated state by controlling the fixing device 30, and turns off the power of a heater disposed inside the upper fixing roller 31. In this step, the control section 70 sets the fixing device 30 in a state where the fixing process is prohibited.

In Step 11 (S11), the control section 70 instructs feeding and reverse conveyance of the sheet P. By the instruction, the sheet P is fed from the sheet feeding section 35 and is conveyed by the main conveyance section 40, then passing through the transfer position and the fixing position, the sheet P reaches the reverse conveyance section 50. Also, the sheet P is conveyed by the reverse conveyance section 50, then after the sheet P is turned over, the sheet P reaches to the conveyance path at the upstream side with respect to the transfer position in the main conveyance section 40 again. Here, since a printing command is not yet inputted at the instruction timing of reverse conveyance in Step 11 and the fixing device 30 is set in the separated state as well as the heater is being turned off, the transfer process with respect to the sheet P at the transfer position and the fixing process onto the sheet P at the fixing position are not performed.

In Step 12 (S12), the control section 70 reads the detection signals of the first and second sheet dimension sensors 75 and 76 corresponding to conveyance of the sheet P in Step 11, and detects the first sheet dimension (hereinafter called “dimension F1”) and the second sheet dimension (hereinafter called “dimension F2”). In the present step, the detected dimensions F1 and F2 are stored in the ROM of the control section 70 as dimensions of the sheet before fixing.

In Step 13 (S13), the control section 70 controls the main conveyance section 40 so as to convey the sheet P returned to the conveyance path of the main conveyance section 40 up to a former stage of the fixing device 30, namely an upstream side with respect to the fixing position, and to stop conveyance of the sheet P at the position.

In Step 14 (S14), the control section 70 controls the fixing device 30 to start fixing temperature control. Specifically, the control section 70 performs on/off control of a power source of the heater so that the temperature of fixing roller becomes a predetermined fixing temperature.

In Step 15 (S15), the control section 70 judges whether or not the fixing roller 31 reaches a fixing temperature. In the Step 15, if it is judged to be positive, namely if it reaches the fixing temperature, operation process proceeds to Step 16 (S16). On the other hand, in case the fixing roller does not reach the fixing temperature, the process in Step 15 is conducted again.

In Step 16, the control section 70 controls the fixing device 30 so as to set the upper fixing roller 31 and the lower fixing roller 32 in a pressurized state. By conducting processes in Steps 14 to 16, the control section 70 sets the fixing device 30 in a state where the fixing process is allowed.

In Step 17 (S17), the control section 70 instructs restart of conveyance and reverse conveyance of the sheet P. With the instruction, the sheet P being stopped at the upstream side with respect to the fixing position is conveyed to the main conveyance section 40 and reaches the reverse conveyance section 50 via the fixing position. Also, after the sheet P is conveyed by the reversal conveyance section 50 and tuned over, the sheet P reaches the conveyance path in the main conveyance section 40 at the upstream side with respect to the transfer position. Here, at the instructed timing of reverse conveyance in Step 17, since the fixing device is in the pressurized state and the fixing temperature control is started, the fixing process onto the sheet P at the fixing position is performed.

In Step 18 (S18), the control section 70 reads the detection signals of the first and the second sheet dimension sensors 75 and 76 in accordance with conveyance of the sheet P in Step 17 and detects the dimension F1 (first sheet dimension) and the dimension F2 (second sheet dimension). In the present Step, the detected dimensions F1 and F2 are stored in the RAM of the control section 70 as the sheet dimensions after the fixing process.

In Step 19 (S19), the control section 70 instructs ejection of the sheet P to ejected sheet fray 46. Specifically, the control section 70 controls the main conveyance section 40 so as to convey the sheet P returned to the conveyance path of the main conveyance section 40 and eject the sheet P onto the ejected sheet tray 46.

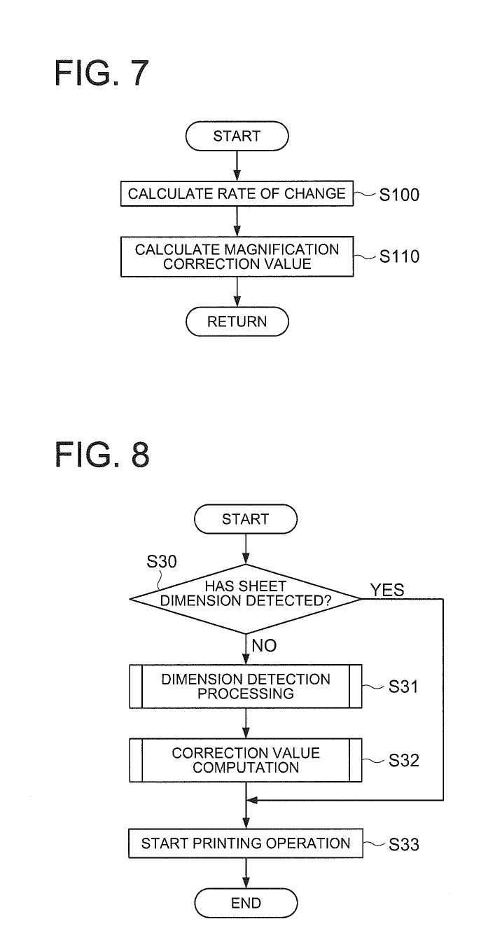

In Step 20 (S20), the control section 70 performs a correction value computation process. Here, FIG. 7 is a flow chart showing details of the correction value computation process. Firstly in Step 100 (S100), the control section 70 respectively reads the dimensions F1 and F2 before fixing and the dimensions F1 and F2 after fixing stored in the RAM. Then the control section 70 calculates a changing ratio (contraction ratio) of the sheet dimensions after the fixing process to before the fixing process with respect to the dimension F1 i.e. the first sheet dimension. Also, the control section 70 calculates the changing ratio of the sheet dimensions after to before fixing process with respect to dimension F2 i.e. the second sheet dimension.

In Step 110 (S110), the control section 70 computes a magnification correction value to correct the magnification ratio of the toner image in a direction parallel (sheet width direction in the main conveyance section 40) to the first sheet dimension, based on the changing ratio of the dimension F1. In the same manner, the control section 70 computes the magnification correction value to correct the magnification ratio of the toner image in a direction parallel (sheet conveyance direction in the main conveyance section 40) to the second sheet dimension, based on the changing ratio of the dimension F2. The computed magnification correction value supersedes a value formerly set as the control parameter to control the image forming unit 10 so as to renew it.

(Second Operation Pattern: Obverse and Reverse Magnification Ratio Associated with Printing Instruction)

Next, operation as for the obverse and reverse magnification ratio correction process as a second operation pattern will be described. Here, FIG. 8 is a flow chart showing a procedure of the obverse and reverse magnification process as the second operation pattern. The process (second operation pattern) shown by the flow chart is executed by the control section 70 along with input of the printing instruction. The printing instruction is inputted to the control section 70 via an unillustrated operation section and so forth.

Here, the operation section located, for example, at an upper section of the apparatus main body is configured with a touch panel through which input operations are possible in accordance with information displayed on a liquid crystal display. The user can instruct the control section 70 about a print command, image forming conditions as the print conditions and sheet conditions via the operation section. Here, the image forming conditions are, for example, printing type i.e. single-side and two-side, density and magnification of the image and number of printing. The sheet conditions are size, type of the sheet such as normal sheet or thick sheet, and weight. Incidentally, input of the printing conditions and the print command to the control section 70 can be conducted not only using the operation section but using personal computers and other image forming apparatuses connected with the image forming apparatus.

First, in Step 30 (S30), the control section 70 judges whether or not the sheet dimension has been detected. As above, the detection of the sheet dimension is conducted along with power activation of the image forming apparatus. However, for example, due to forced termination by the user or jamming of the sheet P, there is a possibility that the detection of the sheet dimension has not been completed. Thus in Step 30, whether or not the sheet dimension detection has been completed or not is judged.

In case a positive judgment is made in Step 30, namely in case the sheet dimension has been detected, the operation process proceeds to Step 33 (S33). On the other hand, in case a negative judgment is made in Step 30, namely in case the sheet dimension has not been detected, operation procedure proceeds to Step 31(S31).

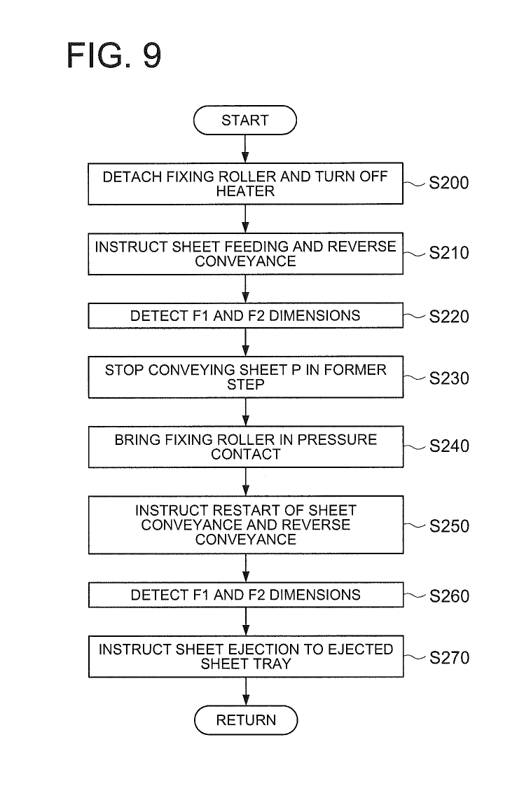

In Step 31, the control section 70 conducts the dimension detection process. FIG. 9 is a flow chart showing details of the dimension detection process. In Step 200 (S200), the control section 70 controls the fixing device 30 so as to set the upper fixing roller 31 and the lower fixing roller 32 in the separated state and to turn off the power of the heater disposed inside the upper fixing roller 31.

In Step 210 (S210), the control section 70 instructs about sheet feeding and reverse conveyance of the sheet P in the same manner as in the aforesaid Step 11. Incidentally, at the instruction timing of reverse conveyance in Step 210, though the print command is inputted, since the operation is in a middle course of the dimension detection process, transferring process onto the sheet P at the transfer position is not performed. Also, since the fixing device 30 is in the separated state and the heater is off, the fixing process onto the sheet P at the fixing position is not conducted either.

In Steps 220 and 230 (S220 and S230), the control section 70 detects the dimensions F1 and F2 as the sheet dimensions before fixing, then controls the main conveyance section 40 so as to convey the sheet P and then to stop conveyance of the sheet P at a stage prior to fixing device 30. Here the process in the step 220 corresponds to the process in the aforesaid Step 12 and the process in Step 230 corresponds to the process in the aforesaid Step 13.

In Steps 240 to 270 (S240 to S270), the control section 70 controls the upper fixing roller 31 and the lower fixing roller 32 to be in the pressurized state then instructs about restart and reverse conveyance of the sheet P and then detects the dimensions F1 and F2 as the sheet dimensions after the fixing process. Then the control section 70 instructs to eject the sheet P onto the ejected sheet tray 46. Here, each of the processes in Steps 240 to 270 corresponds to each of the processes in Steps 16 to 19.

Referring to FIG. 8 again, in Step 32 (S32), the control section 70 performs correction value computation process. The correction value computation process is the same as that in the flow chart in FIG. 7, thus descriptions are omitted.

In Step 33, the control section 70 starts printing operation based on the printing condition designated by the user. The control section 70 controls the image forming unit 10, the fixing device 30, the main conveyance section 40 and the reversal conveyance section 50 so as to form the toner image on the sheet P.

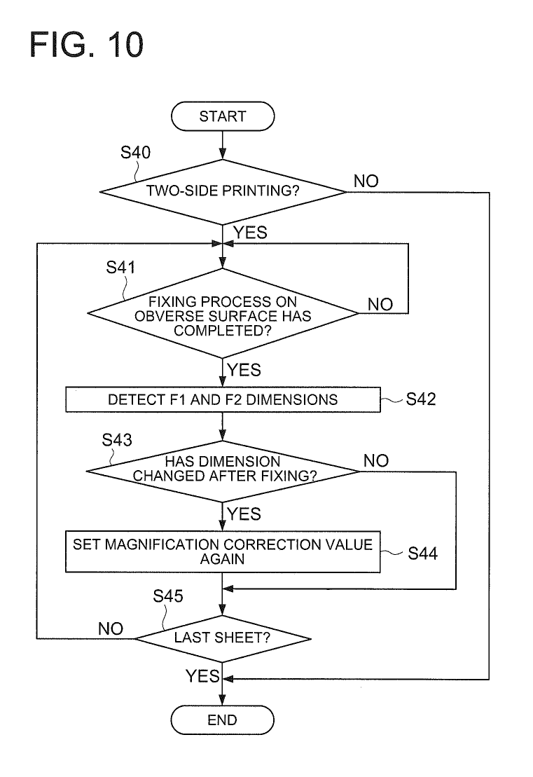

FIG. 10 is a flow chart showing a procedure of the correction processing of the magnification correction value corresponding to the second operation pattern. The processing shown by the flow chart is executed by the control section 70 along with starting of print operation.

In Step 40 (S40), the control section 70 judges whether the printing conditions for current printing operation is for two-side printing. In case judgment result is positive in the Step 40, namely the printing conditions are of the two-side printing, the operation process proceeds to Step 41 (S41). On the other hand, in case the judgment result is negative, namely the printing conditions are not of the two-side printing the present routine is terminated.

In Step 41, the control section 70 judges whether the fixing process with respect to the obverse sheet surface has been completed or not, In case of a positive judgment result in Step 41, namely the fixing process with respect to the obverse sheet surface has been completed, the operation process proceeds to Step 42 (S42). On the other hand in case of a negative judgment result, namely, the fixing process with respect to the obverse surface has not been completed, the judgment in Step 41 is conducted again.

In Step 42, the control section 70 reads the detection signals of the first and second sheet dimension sensors 75 and 76 in course of conveyance of the sheet P on which image fowling on the obverse surface thereof is completed. Thereby the sheet dimensions of after fixing process are detected as the dimensions F1 and F2.

In Step 43 (S43), the control section 70 judges whether or not the dimensions F1 and F2 after the fixing process detected in the first or second operation pattern have changed from the dimensions F1 and F2 detected in Step 42. In case a positive judgment is made in Step 43, namely, in case the sheet dimensions have not changed, the processing procedure proceeds to Step 44 (S44). On the other hand, in Step 43, in case a negative judgment is made, namely, in case the sheet dimensions after fixing process have not changed, the processing procedure proceeds to Step 45 (S45).

In Step 44, the control section 70 sets the magnification correction value again. Specifically, the control section 70 calculates the changing ratio of the dimensions F1 and F2 before and after fixing process based on the dimensions F1 and F2 after fixing detected in Step 42. The control section 70 calculates the magnification correction values respectively based on the changing ratios of the dimensions F1 and F2. The calculated magnification correction values supersede and renew the formerly set value as a control parameter to control the image forming unit.

In step 45 (S45), the control section 70 judges whether or not the sheet P currently subject to printing is a last sheet, in ease there exist one or more the sheets P on which the toner images are to be formed in accordance with the printing command. In Step 45 in case a negative judgment is made, namely the sheet P subject to printing is not the last sheet, a process after Step 41 is conducted with respect to the sheet P subject to printing subsequently. On the other hand in case a positive judgment is made in Step 45, namely the sheet P subject to printing is the last sheet, the present processing procedure is terminated.

(Third Pattern: Obverse and Reverse Magnification Correction Associated with Sheet Setting)

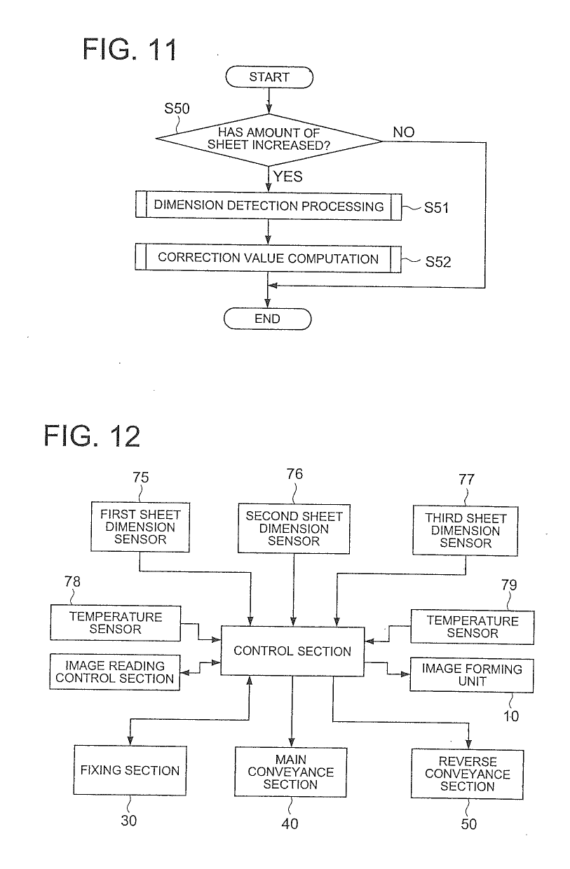

FIG. 11 shows a flow chart showing a processing procedure of obverse and reverse magnification correction as a third pattern. The processing shown by the flow chart (third operation pattern) is executed on condition that the sheet P is set in the sheet feeding section 35.

First, in Step 50 (S50), the control section 70 judges whether the amount of the sheet stored in the sheet storing trays Tr1 and Tr2 increased or not with reference to the detection signal from the sheet amount sensor 77. In Step 50, in case a positive judgment is made, namely in case the amount of the sheet has increased, the processing procedure proceeds to Step 51 (S51). On the other hand, in case a negative judgment is made in Step 50, namely the amount of the sheet has not increased, the present processing procedure is terminated.

The control section 70 performs a dimension detection process in Step 51, and performs a correction value computation process in Step 52 (S52). Here, the dimension detection process is the same process as that shown by the flow chart in FIG. 9, and the correction value computation process is the same process as that shown by the flow chart in FIG. 7. Therefore, descriptions thereof are omitted.

As above, according to the present embodiment, the image forming apparatus is provided with the first sheet detection sensor 75 in the conveyance path of the reverse conveyance section 50, and the first sheet detection sensor 75 detects the first sheet dimension (dimension F1) by detecting the front and the rear edge of the sheet P in course of turning over in the sheet conveyance direction FD2. According to the above configuration, by installing the sensor in the conveyance path of the reverse conveyance section 50, the sheet dimension in the sheet feeding direction only has to be detected, thus it is possible that the first sheet dimension is detected by an economical sensor configuration. Therefore, the first sheet dimension can be accurately detected while suppressing economic burden. Whereby, the first sheet dimension accurately detected can be served as a control parameter to inhibit deviations in size and position between obverse and reverse images.

Also, according to the present embodiment, the image forming apparatus is further provided with the second sheet dimension sensor 76 disposed at the conveyance path configuring the main conveyance section 40 to detect the second sheet dimension (dimension F2) by detecting the front and the rear edges of the sheet P in course of conveyance in the sheet conveyance direction FD1. According to the above configuration, by installing the sensor in the conveyance path of the main conveyance section 40, the second sheet dimension only has to be detected, thus it is possible that the second sheet dimension is detected by an economical sensor configuration.

Also, according to the present embodiment, the control section 70 conducts the magnification correction process including a detection process to detect the first and the second sheet dimensions respectively through the first and the second sheet dimension sensors 75 and 76 and a computation process to calculate the magnification correction value to correct the magnification ratio of the toner image based on the first and the second sheet dimensions. According to the above configuration, the first and the second sheet dimensions are detected without presuming the first sheet dimension. Then based on the above results, the magnification correction value can be calculated accurately. Whereby, the size and the positional relation between the obverse and the reverse images can be matched.

According to the present embodiment, the control section 70 conducts a process to convey the sheet P in the two-side printing path which returns the sheet P to the main conveyance section 40 from the main conveyance section 40 via the reverse conveyance section 50 and a process to respectively detect the first and the second sheet dimensions in a sheet conveyance path. According to the above configuration, the first and the second sheet dimension can be respectively detected while the sheet P is in course of conveyance.

Also, according to the present embodiment, the control section 70 respectively conducts the detection processes in a state where the fixing process is permitted at sheet conveyance and a state where the fixing process is not permitted. According to the above process the sheet dimension before fixing and the sheet dimension after fixing can be detected respectively.

According to the present embodiment, the control section 70 controls the upper fixing roller 31 and the lower fixing roller 32 to be in a separated state and turns off the heater in the state where fixing process is not permitted, and controls the upper fixing roller 31 and lower fixing roller 32 to be in the pressurized state and turns on the heater in the state where fixing process is permitted. Whereby, the sheet dimensions before the fixing process and the sheet dimensions after the fixing process can be detected.

According to the present embodiment, the control section 70 performs the aforesaid computation process based on the result of the detection process in accordance with whether the fixing process is permitted or not. Whereby, the magnification correction value can be calculated accurately.

According to the present embodiment, the control section 70 conducts the magnification correction process at the timing of power activation of the image forming apparatus, printing instruction or sheet setting. According to the above configuration, the magnification correction value can be calculated before forming the toner image or at the time of changing the sheet P.

According to the present embodiment, the control section 70 detects the first and the second sheet dimensions via the first and the second sheet dimension sensors after the fixing process onto the obverse sheet surface in case the two-side printing is carried out according to the printing command, then corrects the magnification correction value based on the detection result. According to the above configuration, the magnification correction value can be set correctly by correcting the magnification correction value every printing operation of the sheets P.

### Second Embodiment

In the first embodiment, there were described operations related to obverse and reverse magnification correction at scenes of ordinary use of the image forming apparatus such as power activation and printing operation. In the second embodiment, operation related to the obverse and reverse magnification correction such as an operation pattern other than the above will be described. Incidentally, descriptions of duplicated configurations and operations with that of the first embodiment will be omitted, and different points will be mainly described.

FIG. 12 is a block diagram showing a control system of the image forming apparatus related to the present embodiment. In the second embodiment, to the control section 70, detected signals from a temperature sensor 78 and a humidity sensor 79 are inputted. The temperature sensor 78 is a sensor to detect temperature of a periphery of the sheet stored in the sheet storing trays Tr1 and Tr2 of the sheet feeding section. The temperature sensor 78 is disposed inside the apparatus body, specifically a vicinity of the sheet feeding section 35. On the other hand, the humidity sensor 79 is a sensor to detect humidity of the periphery of the sheet storing trays Tr1 and Tr2 of the sheet feeding section. The humidity sensor 79 is disposed inside the apparatus body, specifically a vicinity of the sheet feeding section 35.

(Fourth Operation Pattern: Obverse and Reverse Magnification Correction Associated with Change of Environment)

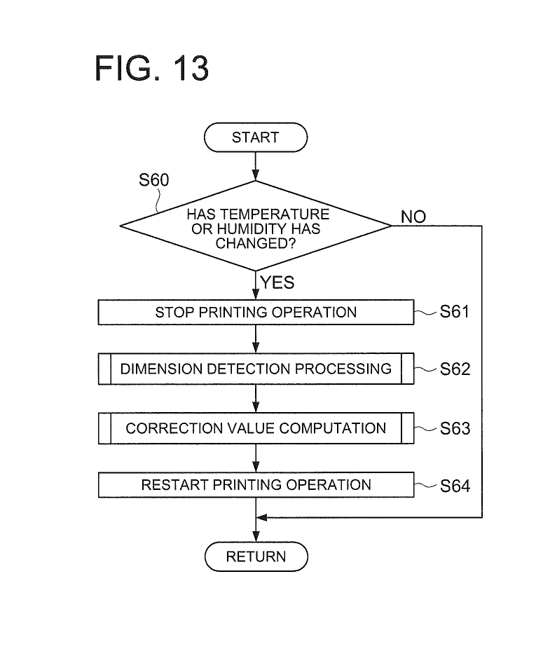

Next, as the fourth pattern, operation related to obverse and reverse magnification correction will be described. Here, FIG. 13 is a flow chart showing a process procedure of the obverse and reverse magnification correction as the fourth pattern. The process (fourth operation pattern) shown in the flow chart is called up at a given cycle after activating the power of the image forming apparatus to be executed by the control section 70.

In Step 60 (S60), when the control section 70 reads the detection signals from the temperature sensor 78 and the humidity sensor 79, the control section 70 judges whether or not any one of or both of the above detection values have been changed exceeding a given value (temperature or humidity) compared to a value at sheet dimension detection before the fixing executed formerly. Since the sheet dimensions change with peripheral environment of the sheet, a scene where the sheet dimension changes is judged using the above judgment. In Step 60, in case a positive judgment is made, namely change of temperature or humidity exceeds the given value, the process procedure proceeds to Step 61 (S61). On the other hand in Step 60 a negative judgment is made, namely change of neither temperature nor humidity does not exceed the given value, the process procedure escapes from the routine.

In Step 61, the control section 70 instructs the print operation to halt. Incidentally, the present step can be omitted in case the current printing operation is not continued, for instance, in course of stand-by.

In Step 62 (S62), the control section 70 conducts the dimension detection process and in Step S63 (S63) the control section 70 conducts the direction value computation process. Here, the dimension detection processing is the same as that shown by the flow chart in FIG. 9 and the correction value computation process is the same as that shown by the flow chart in FIG. 7. Thus the descriptions are omitted.

In Step 64 (S64), the control section 70 instructs the printing operation to restart since the printing operation is instructed to halt in Step 61. Incidentally, in case the process in Step 61 is omitted, the process in the present Step 64 can be omitted.

According to the present embodiment, in case the change of any one of or both of temperature and humidity exceeds a criterion value compared to the temperature and humidity when the magnification correction processing was carried out formerly, the control section 70 conducts the magnification correction processing again. Whereby, the magnification correction value can be appropriately set by conducting the magnification correction process in accordance with change of environment in which changes the sheet dimensions. cl Third Embodiment

In the first embodiment, operation related to obverse and reverse magnification correction at scenes of ordinary use of the image forming apparatus such as power activation and printing operation. In the third embodiment, operation related to the obverse and reverse magnification correction as an operation pattern other than the above will be described. Incidentally, descriptions of duplicated configurations and operations with that of the first embodiment will be omitted, and different points will be mainly described.

(Fifth Pattern: Obverse and Reverse Magnification Correction Associated with Integrated Number of Printing)

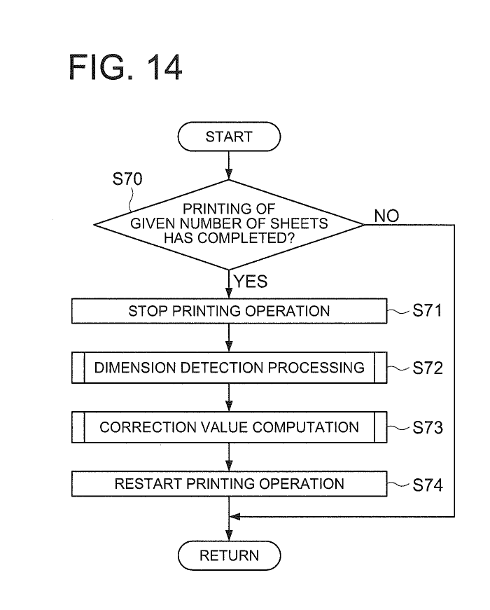

Next, an operation related to the obverse and reverse magnification correction as the fifth operation pattern will be described. Here, FIG. 14 is a flow chart showing a process procedure of the obverse and reverse magnification correction as the fifth pattern. The process (fifth operation pattern) shown by the flow chart is called up at a given cycle after activating power of the image forming apparatus and executed by the control section 70.

In Step 70 (S70), the control section 70 judges whether the integrated number of printing has reached a given number. Here, the integrated number of printing is number of the sheets P having been printed from a base point which is sheet dimension detection before the fixing process carried out formerly.

In Step 70, in case a positive judgment is made, namely after the sheet dimension detection which is before the fixing process, a given number of the sheets (for example, 1000 sheets) have been printed, the process procedure proceeds to Step 71. On the other hand in case a negative judgment is made, namely after the sheet dimension detection which is before fixing process, a given number of the sheets (for example, 1000 sheets) have not been printed, the processing procedure proceeds to Step 71.

In Step 71, the control section 70 instructs the printing operation to stop. Incidentally, the present step can be omitted in case the current printing operation is not continued, for instance, in course of stand-by.

In Step 72 (S72), the control section 70 conducts dimension detection process, and in Step 73 (S73), the control section 70 conducts correction value computation process. Here, the dimension detection process is the same as that shown by the flow chart in FIG. 9 and the correction value computation process is the same as that shown by the flow chart in FIG. 7, thus the descriptions thereof are omitted.

In Step 74 (S74), the control section 70 instructs the printing operation to restart since the printing operation in Step 71 is instructed to stop. Incidentally, in case the process in Step 71 is omitted, the process in the present Step 74 can be omitted.

As above, according to the present embodiment, the control section 70 carries out the magnification correction process again in case the number of the printed sheets integrated from at the time of magnification correction processing formerly conducted reaches the criteria number. Thereby, by carrying out the magnification correction process in accordance with the printing number, the magnification correction value can be set appropriately.

As above, while the image forming apparatus related to the embodiments of the present invention have been described, the present invention is not limited to the embodiments thereof and it is to be understood that changes and variations may be made without departing from the spirit or scope of the appended claims. For example, in the above embodiments, while the reverse conveyance section to turn over the sheet is stored in the main body (housing) of the image forming apparatus, the reverse conveyance section can be installed outside the main body of the apparatus.

According to the above embodiments, the first dimension can be detected with an economical sensor configuration since while the sheet is in course of turning over the sheet dimension in the sheet conveyance direction has only to be detected by disposing a sensor in the conveyance path in the reversal conveyance section. Therefore, the firs sheet dimension can be detected accurately while suppressing the burden of the economy. Therefore, the first sheet dimension having been detected accurately can be provided as a control parameter to inhibit the difference of the size and the displacement between the images on the obverse and reverse surfaces.

What is claimed is:

1. An image forming apparatus to form images on obverse and reverse surfaces of a sheet by transferring the images onto the sheet and fixing the images transferred onto the sheet, comprising:
a main conveyance section to convey the sheet to a fixing position where the image transferred from a transfer position is fixed on the sheet, wherein in the transfer position the image is transferred onto the sheet;
a reverse conveyance section to receive the sheet passed through the fixing position from the main conveyance section and to turn over the sheet by rotating the sheet around a rotation axis parallel to a sheet conveyance direction at the transfer position, and
a first dimension detection section to detect a first sheet dimension by detecting front and rear edges of the sheet in a sheet conveyance direction while the sheet is being turned over.

2. The image forming apparatus of claim 1, further comprising:
a second dimension detection section provided at a conveyance path of the main conveyance section to detect a second sheet dimension by detecting the front and the rear edges of the sheet in course of conveyance in the sheet conveyance direction.

3. The image forming apparatus of claim 2, further comprising:
a control section to conduct a magnification correction process including a detection process to detect the first sheet dimension and the second sheet dimension through the first dimension detection section and the second dimension detection section, and a computation process to compute a magnification correction value which corrects a magnification of the image based on the first sheet dimension and the second sheet dimension.

4. The image forming apparatus of claim 3, wherein as the detection process the control section conducts a process to convey the sheet through a two-side printing path which is a recurrence path from the main conveyance section to the main conveyance section via the reverse conveyance section and a process to detect the first and the second sheet dimensions respectively in course of the sheet conveyance.

5. The image forming apparatus of claim 3, further comprising a fixing device to conduct a fixing process with respect to the sheet conveyed to the fixing position, wherein the control section conducts the detection processes respectively in accordance with a state in which the fixing process is permitted at a time of the sheet conveyance and a state in which the fixing process is not permitted at the time of the sheet conveyance.

6. The image forming apparatus of claim 5, wherein the fixing device comprises: a pair of fixing members disposed oppositely each other via a sheet conveyance surface of a conveyance path in the main conveyance section and configured to enable switching between a pressurized state and a separated state, and a heating section to heat the fixing members,
wherein the control section controls the pair of the fixing members to be in a separated state and turns off a power source of the heating section in the state where fixing is not permitted, and controls the pair of the fixing members to be in a pressurized state and turns on the power source of the heating section in the state where fixing is permitted.

7. The image forming apparatus of claim 5, wherein the control section conducts the computation process based on respective results of the detection processes in accordance with whether or not the fixing process is permitted.

8. The image forming apparatus of claim 3, wherein the control section conducts the magnification correction process at time of activating power of the image forming apparatus.

9. The image forming apparatus of claim 3, wherein the control section conducts the magnification correction process at time of instructing printing or at time of setting the sheet.

10. The image forming apparatus of claim 8, wherein the control section conducts the magnification correction process again in case a change of any one of or both of temperature and humidity exceeds a criterion value compared to temperature or humidity at time of the magnification correction process formerly conducted.

11. The image forming apparatus of claim 8, wherein the control section conducts the magnification correction process again, in case a printing number of the sheets integrated from at time of the magnification correction process formerly conducted reaches a criterion printing number.

12. The image forming apparatus of claim 8, wherein in case of the two-side printing is conducted in accordance with a printing command, the control section detects the first and the second sheet dimensions via the first dimension detection section and the second dimension detection section after fixing the image on the obverse surface of the sheet and conducts the magnification correction process based on the detection results.
